(19) United States
(12) Patent Application Publication
(10) Pub. No.: US 2013/0122970 A1
(43) Pub. Date: May 16, 2013

(54) MOBILE COMMUNICATION DEVICE AND WIRELESS COMMUNICATION SIGNAL ADJUSTING METHOD THEREOF

(71) Applicant: Chia-Wen SU, New Taipei City (TW)

(72) Inventor: Chia-Wen SU, New Taipei City (TW)

(21) Appl. No.: 13/471,067

(22) Filed: May 14, 2012

(30) Foreign Application Priority Data
Nov. 15, 2011 (TW) 100141677

(51) Int. Cl. H04B 1/40

(52) U.S. Cl. 455/572

(57) ABSTRACT

A mobile communication device and a wireless communication signal adjusting method thereof are disclosed. The mobile communication device includes an antenna module, a wireless signal processing module, a sensor module, and a first adjust module. The antenna module is used for transferring the wireless communication signal. The wireless signal processing module is electrically connected to the antenna module via a first match circuit, and used for receiving or transmitting the wireless communication signal. The sensor module is used for sensing a position of a human body, and generating a high voltage signal when the human body is approaching. When the sensor module generates the high voltage signal, the first adjust module is used for controlling the antenna module to further electrically connect a second match circuit and changing a frequency response to reduce the energy of the wireless communication signal.

### BACKGROUND OF THE INVENTION

1. Field of the Invention

The present invention relates to a mobile communication device and a wireless communication signal adjusting method thereof; more particularly, the present invention relates to a mobile communication device which can change the frequency response inside and a wireless communication signal adjusting method thereof.

2. Description of the Related Art

As technology develops, the mobile communication device is applied widely in daily life. The mobile communication device includes the function of transmitting a wireless communication signal. In order to prevent the electromagnetic wave of the mobile communication device to affect the human body when the user uses the mobile communication device, the mobile communication device must pass the test of SAR (Specific Absorption Rate) which is a measuring of the rate at which energy is absorbed by the body when exposed to a radio frequency electromagnetic field.

In order to adjust the SAR, the method of reducing the energy of the signal transmitted by the mobile communication device when a human body is approaching, is already disclosed in the prior art. The mobile communication device usually reduces the electromagnetic wave by switching the different antennas. However, the inside of the mobile communication device must include the additional space to locate a plurality of antenna modules; for the modern mobile communication device which is required to be small and light, the inside of the mobile communication device must include a more complex circuit layout to meet those requirements, such that the cost will increase.

Therefore, there is a need to provide a new mobile communication device and a wireless communication signal adjusting method thereof, to solve the problem of the prior art.

### SUMMARY OF THE INVENTION

It is an object of the present invention to provide a mobile communication device which can change the frequency response inside.

It is another object of the present invention to provide a wireless communication signal adjusting method.

To achieve the abovementioned object, the mobile communication device of the present invention comprises an antenna module, a wireless signal processing module, a sensor module, and a first adjust module. The antenna module is used for transferring the wireless communication signal.

The wireless signal processing module is electrically connected to the antenna module via a first match circuit, for receiving or transmitting the wireless communication signal. The sensor module is used for sensing a position of a human body, and generating a high voltage signal when the human body is approaching. The first adjust module is electrically connected to the sensor module and the second match circuit. When the sensor module generates the high voltage signal, the first adjust module is used for controlling the antenna module to further electrically connect the second match circuit, and changing a frequency response to reduce the energy of the wireless communication signal.

The wireless communication signal adjusting method of the present invention comprises the steps of: receiving or transmitting the wireless communication signal via a first match circuit; sensing a position of a human body; determining whether the human body approaches to the mobile communication device; generating a high voltage signal if the human body approaches to the mobile communication device; controlling the antenna module to electrically connect to a second match circuit according to the high voltage signal, to change a frequency response and reduce the energy of the wireless communication signal.

### BRIEF DESCRIPTION OF THE DRAWINGS

FIG. 1 illustrates a structure schematic drawing of the mobile communication device of the present invention in the first embodiment.

FIG. 2 illustrates a structure schematic drawing of the mobile communication device of the present invention in the second embodiment.

FIG. 3 illustrates a structure schematic drawing of the mobile communication device of the present invention in the third embodiment.

FIG. 4 illustrates a step flowchart of the wireless communication signal adjusting method of the present invention.

### DETAILED DESCRIPTION OF THE PREFERRED EMBODIMENTS

These and other objects and advantages of the present invention will become apparent from the following description of the accompanying drawings, which disclose several embodiments of the present invention. It is to be understood that the drawings are to be used for purposes of illustration only, and not as a definition of the invention.

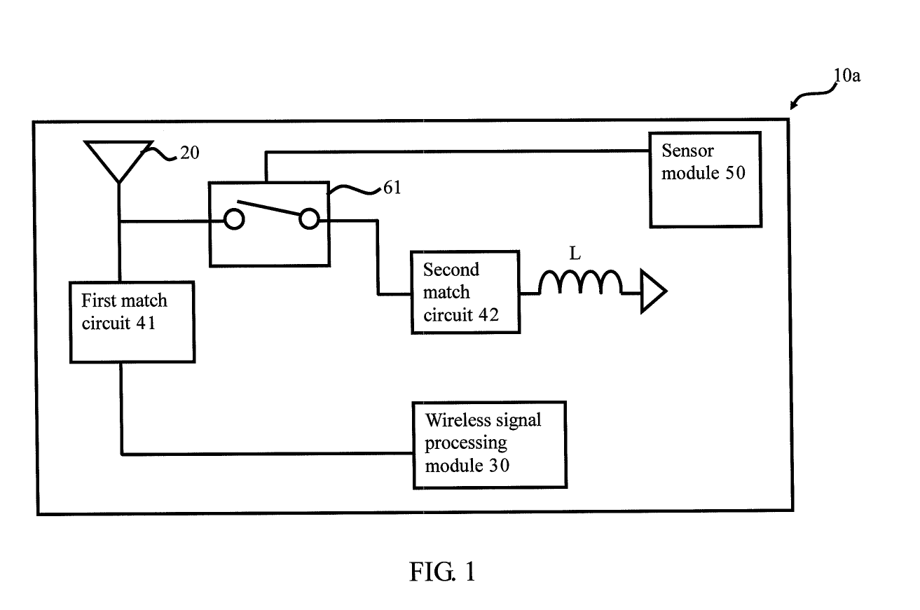

Please refer to FIG. 1, which illustrates a structure schematic drawing of the mobile communication device of the present invention in the first embodiment.

The mobile communication device 10a of the present invention can be a cellphone, a personal digital assistant, a notebook computer, or a tablet computer, but the present invention is not limited to those abovementioned devices. The mobile communication device 10a can transfer the wireless communication signal, and adjust the strength of the electromagnetic wave of the wireless communication signal according to the distance between the human body and the mobile communication device 10a. In the first embodiment of the present invention, the mobile communication device 10a comprises an antenna module 20, a wireless signal processing module 30, a first match circuit 41, a second match circuit 42, a sensor module 50, a first adjust module 61, an inductance element L, and other circuit elements, such as an analog to digital converter. The inductance element L is used for blocking the high-frequency signal to loss towards the DC voltage source, to prevent the gain loss. The circuit elements such as the inductance element L or the analog to digital converter is applied widely to many kinds of electronic devices, and it is not the focus of the present invention, so there is no need to describe here.

The antenna module 20 can comprise an antenna or a plurality of antenna, for transferring the wireless communication signal of many kinds of frequency. The antenna type or the amount of the antenna module 20 is designed according to the requirement of the mobile communication device 10a, but the present invention is not limited to that design. The wireless signal processing module 30 is formed from a hardware, or a hardware combined with a firmware. The wireless signal processing module 30 is electrically connected to the antenna module 20 for receiving or transferring the wireless communication signal.

The first match circuit 41 and the second match circuit 42 can comprise the circuit elements such as the resistors, the capacitors, or the elements which can change the frequency response, for providing the frequency response when the antenna module 20 transfers the signal, to further affect the energy of transferring the wireless communication signal.

The connecting of the wireless signal processing module 30 and the antenna module 20 is directly and electrically connected to the first match circuit 41; therefore, the wireless signal processing module 30 receives or transmits the wireless communication signal via the first match circuit 41. It can be seen that the first match circuit 41 directly affect the energy of the wireless communication signal.

The sensor module 50 is formed from a hardware circuit, but the present invention is not limited to that design. The sensor module 50 can be a proximity sensor which is based on the infrared signal and the detecting of the light sensor, to determine the position of the human body according to the reflecting of the infrared signal and the strength of the sensing of the light, such that the distance between the hand or the head of the human body and the mobile communication device 10a can be known. When the hand or the head of the human body approaches or leaves, the mobile communication device 50 generates the corresponding signal. In the embodiment of the present invention, when the human body approaches, the sensor module 50 generates a high voltage signal; when the human body leaves, the sensor module 50 keeps to output a low potential signal, but the present invention is not limited to that design.

The first adjust module 61 is electrically connected to the sensor module 50 and the second match circuit 42, the first adjust module 61 is a switch module, for determining whether the antenna module 20 connects to the second match circuit 42. In the first embodiment of the present invention, the first adjust module 61 can be a diode, but the present invention is not limited to that design. When the sensor module 50 generates the high voltage signal, the first adjust module 61 is conducted base on the feature of the diode, allowing the antenna module 20 to additionally and electrically connect to the second match circuit 42. Since the second match circuit 42 can also affect the frequency response, such that when the antenna module 20 is electrically connected to the first match circuit 41 and the second match circuit 42 at the same time, the frequency response will be changed to reduce the energy of the wireless communication signal. On the other hand, when the sensor module 50 does not generate the high voltage signal, the first adjust module 61 can open circuit of the antenna module 20 and the second match circuit 42, to keep the energy of the wireless communication signal.

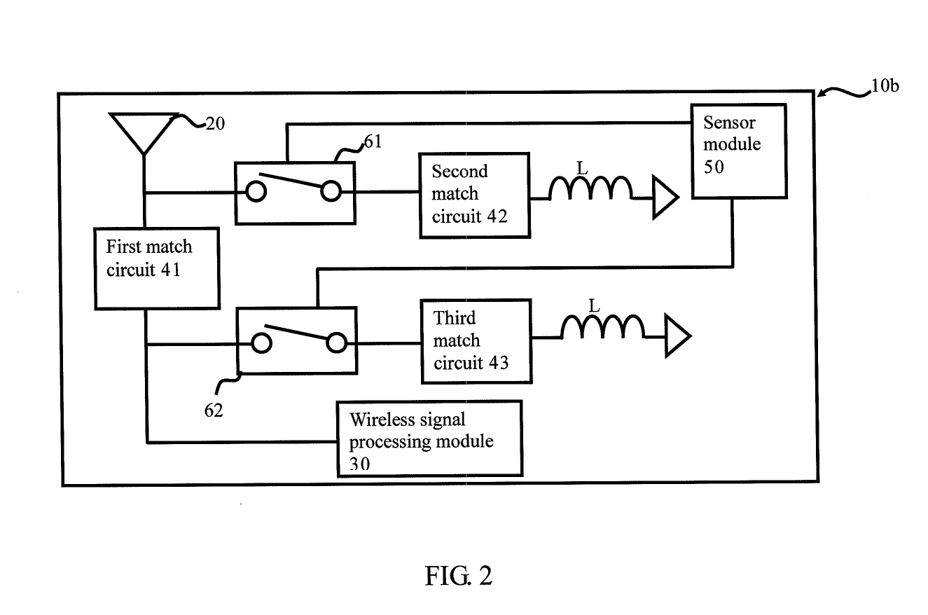

Please refer to FIG. 2, which illustrates a structure schematic drawing of the mobile communication device of the present invention in the second embodiment.

In the second embodiment of the present invention, the mobile communication device 10b further comprises a third match circuit 43 and a second adjust module 62. The third match circuit 43 is similar to the second match circuit 42; the third match circuit 43 and the second match circuit 42 both can change the frequency response. The second adjust module 62 is electrically connected to the third match circuit 43 and the sensor module 50, the second adjust module 62 can be a diode as a switch. Therefore, when the sensor module 50 generates the high voltage signal, the second adjust module 62 controls the antenna module 20 to electrically connect to the third match circuit 43; such that the antenna module 20 is electrically connected to the first match circuit 41, the second match circuit 42, and the third match circuit 43 at the same time, to reduce the energy of the wireless communication signal via changing the frequency response.

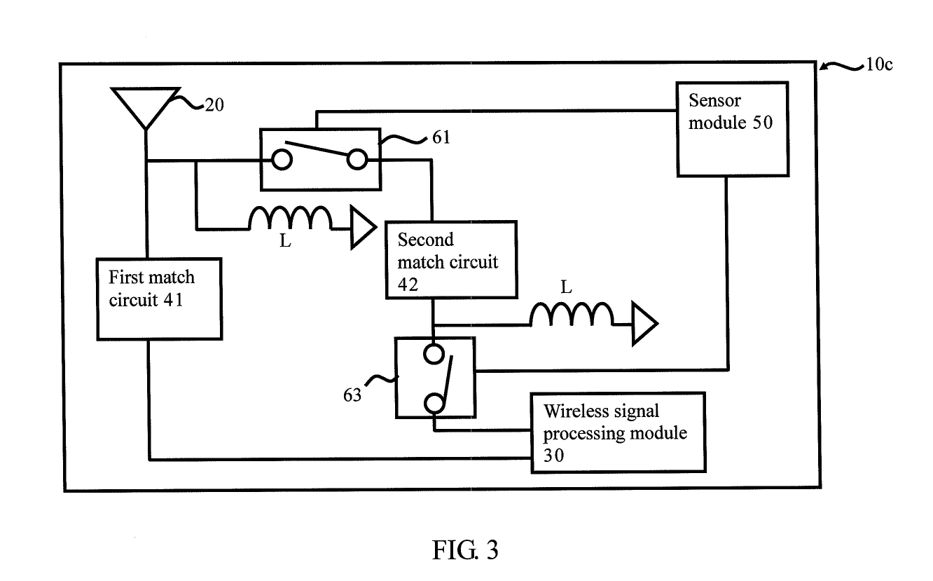

Please refer to FIG. 3, which illustrates a structure schematic drawing of the mobile communication device of the present invention in the third embodiment.

In the third embodiment of the present invention, the mobile communication device 10c comprises a third adjust module 63. The third adjust module 63 is similar to the first adjust module 61, it can be a diode as a switch. The third adjust module 63 is connected between the second match circuit 42 and the wireless signal processing module 30, and also electrically connected to the sensor module 50. The first adjust module 61 and the third adjust module 63 are connected to the second match circuit 42 at the same time. Therefore, when the sensor module 50 generates the high voltage signal, the first adjust module 61 and the third adjust module 63 are conducted at the same time, and the wireless signal processing module 30 can be electrically connected to the antenna module 20 via the additional second match circuit 42. It can be seen that the second match circuit 42 and the first match circuit 41 are in the parallel relationship, to adjust the frequency response to reduce the energy of the wireless communication signal.

It is to be understood that, the present invention is not limited to the abovementioned embodiment, which means the second adjust module 62 and the third match circuit 43 can be added to the mobile communication device 10c depends on the requirement; the present invention is not limited to the connecting relationship of each matching circuit.

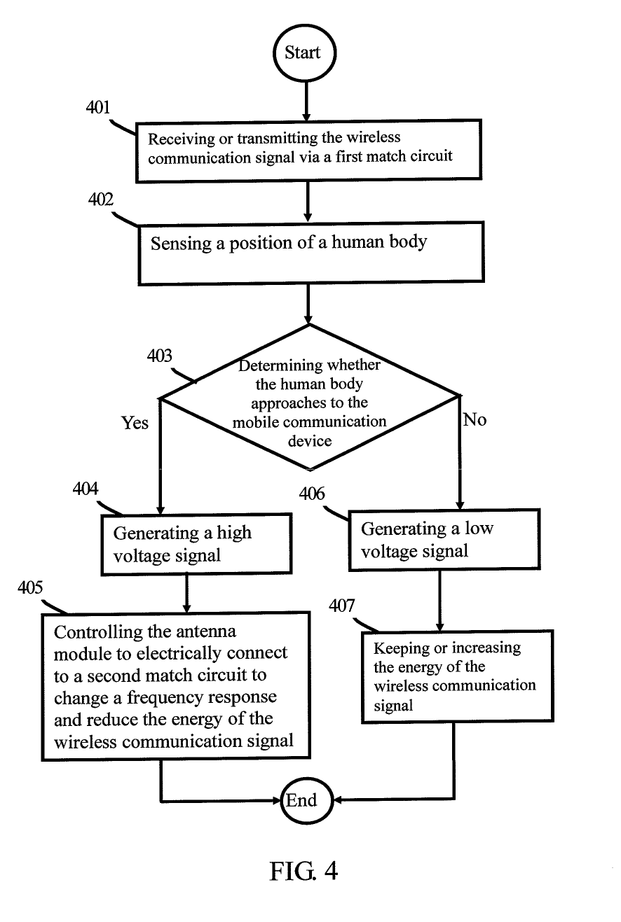

Please refer to FIG. 4, which illustrates a step flowchart of the wireless communication signal adjusting method of the present invention. It is to be understood that, the wireless communication signal adjusting method of the present invention takes the mobile communication device 10a as an example in the following description, but the wireless communication signal adjusting method of the present invention is not limited to the abovementioned mobile communication device 10a.

The method starts at Step 401: receiving or transmitting the wireless communication signal via a first match circuit.

The mobile communication device 10a transfers the wireless communication signal via the antenna module 20, then the wireless signal processing module 30 receives or transmits the wireless communication signal via the first match circuit 41. Because this step is already disclosed in the prior art for the mobile communication device 10a, there is no need to describe here.

Then the method goes to Step 402: sensing a position of a human body. The sensor module 50 senses the external environment changing of the mobile communication device 10a. The sensor module 50 is based on the infrared signal and the detecting of the light sensor, to determine the position of the human body according to the reflecting of the infrared signal and the strength of the sensing of the light.

Then the method goes to Step 403: determining whether the human body approaches to the mobile communication device. Then the sensor module 50 determines whether the head or the hand of the human body approaches to the mobile communication device 10a according to the reflecting of the infrared signal and the strength of the sensing of the light.

When the sensor module 50 determines that the hand or the head of the human body approaches to the mobile communication device 10a, the method goes to Step 404: generating a high voltage signal.

If the sensor module 50 determines that the hand or the head of the human body approaches to the mobile communication device 10a, the sensor module 50 generates the high voltage signal, and transfers the high voltage signal to the first adjust module 61.

Then the method goes to Step 405: controlling the antenna module to electrically connect to a second match circuit to change a frequency response and reduce the energy of the wireless communication signal.

In order to prevent the human body to be affected by the electromagnetic wave, the first adjust module 61 switches after receiving the high voltage signal, allowing the antenna module 20 to electrically connect to the second match circuit 42, to change the frequency response between the antenna module 20 and the wireless signal processing module 30, to further reduce the energy of the wireless communication signal.

Therefore, the energy of the wireless communication signal transferred by the mobile communication device 10a can be reduces, but the present invention is not limited to the abovementioned way to reduce the energy of the wireless communication signal. Besides the abovementioned mobile communication device 10a of the first embodiment, the mobile communication device 10b of the second embodiment of the present invention can also control the antenna module 20, to further electrically connect to the third match circuit 43 according to the high voltage signal; or according to the high voltage signal, the circuit of the mobile communication device 10c of the third embodiment can also control the wireless signal processing module 30 to further electrically connect the antenna module 20 via the second match circuit 42, to reduce the energy of the wireless communication signal.

If the sensor module 50 determines that the hand or the head of the human body does not approach the mobile communication device 10a, then the method goes to Step 406: generating a low voltage signal.

If the sensor module 50 determines that the hand or the head of the human body does not approach the mobile communication device 10a, the sensor module 50 generates the low voltage signal, and transfers the low voltage signal to the first adjust module 61.

Finally the method goes to Step 407: keeping or increasing the energy of the wireless communication signal.

If the sensor module 50 determines that the hand or the head of the human body does not approach the mobile communication device 10a, in order to increase the transferring performance of the mobile communication device 10a, the first adjust module 61 does not execute the circuit switching, or to open circuit of the antenna module 20 and the second match circuit 42, allowing the mobile communication device 10a to increase or keep the energy of the wireless communication signal.

It is to be understood that, the wireless communication signal adjusting method of the present invention is not limited to the abovementioned steps sequence, the steps sequence can be changed if the object of the present invention is achieved.

Via the abovementioned embodiment, the mobile communication device 10a, 10b, or 10c can use simple circuit to achieve the object of adjusting the energy of the wireless communication signal transferred by the antenna module 20.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A mobile communication device comprising:
an antenna module, for transferring a wireless communication signal;
a wireless signal processing module electrically connected to the antenna module via a first match circuit, for receiving or transmitting the wireless communication signal;
a sensor module for sensing a position of a human body, and generating a high voltage signal when the human body is approaching; and
a first adjust module is electrically connected to the sensor module and a second match circuit; when the sensor module generates the high voltage signal, the first adjust module controls the antenna module to further electrically connect to the second match circuit according to the high voltage signal, to change a frequency response and reduce an energy of the wireless communication signal.

2. The mobile communication device as claimed in claim 1, further comprising a second adjust module electrically connected to a third match circuit and the sensor module; when the sensor module generates the high voltage signal, the second adjust module controls the antenna module to further electrically connect to the third match circuit according to the high voltage signal, to change the frequency response.

3. The mobile communication device as claimed in claim 2, wherein the second adjust module is a diode.

4. The mobile communication device as claimed in claim 1, further comprising a third adjust module electrically connected to the sensor module and the second match circuit; when the sensor module generates the high voltage signal, the first adjust module and the third adjust module control the wireless signal processing module to further electrically connect to the antenna module according to the high voltage signal, to change the frequency response via the second match circuit.

5. The mobile communication device as claimed in claim 4, wherein the third adjust module is a diode.

6. The mobile communication device as claimed in claim 1, wherein the first adjust module is a diode.

7. The mobile communication device as claimed in claim 1, wherein if the sensor module does not generate the high voltage signal, the first adjust module is used for keeping or increasing the energy of the wireless communication signal.

8. The mobile communication device as claimed in claim 1, wherein the sensor module is a proximity sensor.

9. A wireless communication signal adjusting method applied to a mobile communication device, wherein the mobile communication device transmits a wireless communication signal to a wireless signal processing module via an antenna module, the wireless communication signal adjusting method comprising:
receiving or transmitting the wireless communication signal via a first match circuit;
sensing a position of a human body;
determining whether the human body approaches to the mobile communication device;
generating a high voltage signal if the human body approaches to the mobile communication device;
controlling the antenna module to electrically connect to a second match circuit according to the high voltage signal, to change a frequency response and reduce an energy of the wireless communication signal.

10. The wireless communication signal adjusting method as claimed in claim 9, further comprising:
controlling the wireless signal processing module to further electrically connect to the antenna module via the second match circuit according to the high voltage signal, to change the frequency response.

11. The wireless communication signal adjusting method as claimed in claim 9, further comprising:
controlling the antenna module to further electrically connect to a third match circuit according to the high voltage signal, to change the frequency response.

12. The wireless communication signal adjusting method as claimed in claim 9, further comprising:
generating a low potential signal if the human body does not approach the mobile communication device; and
keeping or increasing the energy of the wireless communication signal.
